(19) United States
(12) Patent Application Publication
(10) Pub. No.: US 2022/0004192 A1
(43) Pub. Date: Jan. 6, 2022

(54) MOVING BODY

(71) Applicant: Panasonic Intellectual Property Management Co., Ltd., Osaka (JP)

(72) Inventors: TATSUO SAKAI, Osaka (JP); KEN TAKAMINE, Osaka (JP)

(21) Appl. No.: 17/352,417

(22) Filed: Jun. 21, 2021

(30) Foreign Application Priority Data
Jul. 3, 2020 (JP) 2020-115912

(51) Int. Cl. G05D 1/02

(52) U.S. Cl. CPC G05D 1/0214; G05D 1/0088; G05D 1/0217

(57) ABSTRACT

A moving body includes a path generator that generates a path for a moving body toward a destination by connecting the plurality of nodes, a movement controller that controls a movement of the moving body such that the moving body moves forward according to the path, and an obstacle detector that detects an obstacle. When the obstacle detector detects an obstacle that restricts a forward movement and a direction change of the moving body, the movement controller causes the moving body to move backward toward a retreat destination node which is a node existing at a position behind the moving body where the moving body can arrive, causes the moving body to execute a direction change to a direction in which the moving body can move forward toward the destination, and causes the moving body to move forward toward the destination.

### BACKGROUND

### 1. Technical Field

The present disclosure relates to a moving body that moves according to a path generated by connecting a plurality of nodes set in advance.

### 2. Description of the Related Art

For example, Japanese Patent Unexamined Publication No. 2005-50105 discloses a moving body that moves according to a path generated by connecting a plurality of nodes set in advance. The moving body holds information on the plurality of nodes, and when information on a destination is provided, generates the path from a current position to the destination by connecting the plurality of nodes. The moving body moves forward according to the generated path.

In addition, the moving body disclosed in Japanese Patent Unexamined Publication No. 2005-50105 can detect an obstacle, and when an obstacle is detected ahead when moving forward according to the path, avoids the obstacle while moving forward.

### SUMMARY

According to an aspect of the present disclosure,

a moving body includes:

a path generator that selects nodes from a plurality of nodes set in advance and generates a path for a moving body toward a destination by connecting the selected nodes;

a movement controller that controls a movement of the moving body such that the moving body moves forward according to the path; and

an obstacle detector that detects an obstacle.

When the obstacle detector detects an obstacle that restricts a forward movement and a direction change of the moving body, the movement controller causes the moving body to move backward toward a retreat destination node which is a node existing at a position behind the moving body where the moving body can arrive, causes the moving body to execute a direction change to a direction in which the moving body can move forward toward the destination, and causes the moving body to move forward toward the destination.

### BRIEF DESCRIPTION OF THE DRAWINGS

FIG. 1 is a schematic perspective view of a moving body according to an exemplary embodiment of the present disclosure;

FIG. 2 is a block diagram of the moving body;

FIG. 3 is a diagram illustrating an example of a path generated by connecting a plurality of nodes;

FIG. 4 is a diagram illustrating an example of each passage determination range of a plurality of nodes;

FIG. 5A is a diagram illustrating a node before the passage determination range is changed;

FIG. 5B is a diagram illustrating the node after the passage determination range is changed;

FIG. 6A is a diagram illustrating an example of an obstacle existing ahead of the moving body;

FIG. 6B is a diagram illustrating an example of a path avoiding the obstacle;

FIG. 7A is a diagram illustrating an example of a moving body situation in which a destination is positioned ahead and there is an obstacle which restricts the forward movement and the direction change;

FIG. 7B is a diagram illustrating a moving body situation following the situation illustrated in FIG. 7A;

FIG. 7C is a diagram illustrating a moving body situation following the situation illustrated in FIG. 7B;

FIG. 7D is a diagram illustrating a moving body situation following the situation illustrated in FIG. 7C;

FIG. 8A is a diagram illustrating another example of a moving body situation in which a destination is positioned ahead and there is an obstacle which restricts the forward movement and the direction change;

FIG. 8B is a diagram illustrating a moving body situation following the situation illustrated in FIG. 8A;

FIG. 8C is a diagram illustrating a moving body situation following the situation illustrated in FIG. 8B;

FIG. 9 is a diagram for explaining a method of determining a retreat destination node;

FIG. 10 is a diagram for explaining a method of determining a retreat destination node;

FIG. 11A is a diagram illustrating an example of a moving body situation in which a destination is positioned behind and there is an obstacle which restricts the forward movement and the direction change;

FIG. 11B is a diagram illustrating a moving body situation following the situation illustrated in FIG. 11A;

FIG. 11C is a diagram illustrating a moving body situation following the situation illustrated in FIG. 11B;

FIG. 11D is a diagram illustrating a moving body situation following the situation illustrated in FIG. 11C;

FIG. 11E is a diagram illustrating a moving body situation following the situation illustrated in FIG. 11D;

FIG. 11F is a diagram illustrating a moving body situation following the situation illustrated in FIG. 11E;

FIG. 12A is a diagram illustrating another example of a moving body situation in which a destination is positioned behind;

FIG. 12B is a diagram illustrating a moving body situation following the situation illustrated in FIG. 11A;

FIG. 12C is a diagram illustrating a moving body situation following the situation illustrated in FIG. 11B;

FIG. 12D is a diagram illustrating a moving body situation following the situation illustrated in FIG. 11C;

FIG. 12E is a diagram illustrating a moving body situation following the situation illustrated in FIG. 11D;

FIG. 12F is a diagram illustrating a moving body situation following the situation illustrated in FIG. 11E; and

FIG. 13 is a flowchart illustrating an example of a processing flow until the moving body arrives at the destination.

### DETAILED DESCRIPTION

In some cases, there may be an obstacle that restricts a forward movement and a direction change of the moving body in the vicinity of the moving body. As a result, the moving body may not be able to move forward toward the destination.

In the moving body that moves according to a path generated by connecting a plurality of nodes, the present disclosure enables the moving body to move forward toward the destination even if there is the obstacle which restricts the forward movement and the direction change.

Hereinafter, an exemplary embodiment of the present disclosure will be described in detail with reference to the drawings. However, excessively detailed description may be omitted. For example, detailed description of already well-known matters and duplicate descriptions for substantially the same configuration may be omitted. This is to avoid unnecessary redundancy of the following description and to facilitate the understanding of those skilled in the art.

The inventor (or inventors) provides the accompanying drawings and the following descriptions in order for those skilled in the art to fully understand the present disclosure, and does not intend to limit the gist described in the Claims.

Hereinafter, a moving body according to an exemplary embodiment of the present disclosure will be described with reference to the drawings.

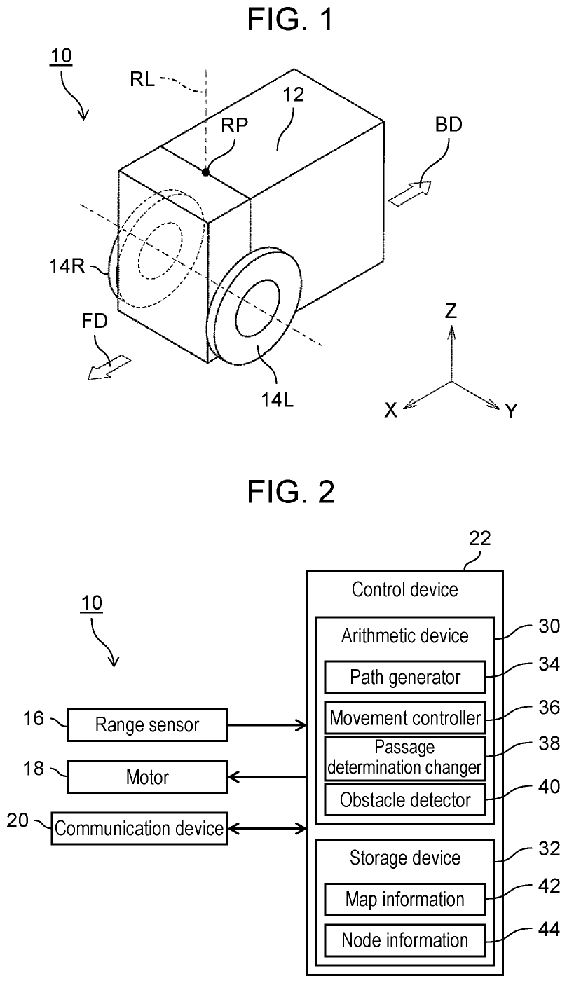

FIG. 1 is a schematic perspective view of a moving body according to an exemplary embodiment of the present disclosure. In addition, FIG. 2 is a block diagram of the moving body. The XYZ Cartesian coordinate system illustrated in FIG. 1 is for facilitating the understanding of the present disclosure, and does not limit the present disclosure. The X-axis direction indicates a front-rear direction of the moving body, the Y-axis direction indicates a lateral direction of the moving body, and the Z-axis direction indicates a height direction.

Moving body 10 is a moving body that performs so-called autonomous movement, and includes main body 12 and a pair of wheels 14L and 14R attached to main body 12 in case of the present exemplary embodiment. When each of wheels 14L and 14R rotates forward at the same rotation speed, moving body 10 travels forward (in the direction of arrow FD) (moves forward). In addition, when each of wheels 14L and 14R reversely rotates at the same rotation speed, moving body 10 travels backward (in the direction of arrow BD) (moves backward). In addition, when each of wheels 14L and 14R rotates at different rotation speeds, moving body 10 changes the direction. The forward travel and the direction change, and the backward travel and the direction change can be executed at the same time.

In the present exemplary embodiment, rotation center lines of wheels 14L and 14R are positioned on the same straight line. Therefore, when one of wheels 14L and 14R rotates forward and the other rotates reversely at the same rotation speed, moving body 10 can execute a pivot turn. In the present exemplary embodiment, reference point RP of moving body 10 is positioned on turning center line RL of the pivot turn. In addition, in the present exemplary embodiment, reference point RP is positioned at a front side of the center of moving body 10 in the front-rear direction (X-axis direction).

As illustrated in FIG. 2, moving body 10 includes range sensor 16 for detecting obstacles around moving body 10, motor 18 for rotating wheels 14L and 14R, communication device 20 for exchanging signals with external device, and control device 22.

Range sensor 16 is, for example, a laser sensor or an ultrasonic sensor that is mounted on main body 12 of moving body 10 for detecting the obstacles existing around moving body 10. The result of measurement by range sensor 16 is transmitted to control device 22.

Motor 18 is mounted on main body 12 of moving body 10 and rotationally drives wheels 14L and 14R. In addition, motor 18 is controlled by control device 22.

Communication device 20 is mounted on main body 12 of moving body 10 and exchanges the signals and information with the external device (not illustrated) positioned outside moving body 10. Moving body 10 acquires information of a final destination of moving body 10 via communication device 20.

Control device 22 is configured with, for example, arithmetic device 30 such as a CPU and storage device 32 such as a memory or a hard disk.

Arithmetic device 30 includes path generator 34, movement controller 36, passage determination changer 38, and obstacle detector 40. When arithmetic device 30 is a CPU, the CPU functions as path generator 34 or the like by an operation according to a program stored in storage device 32.

Path generator 34 of arithmetic device 30 generates a path for moving body 10 to move toward the destination.

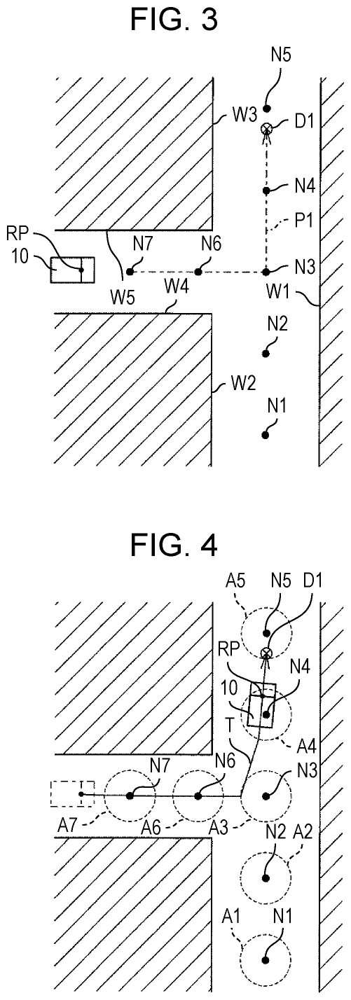

FIG. 3 illustrates an example of a path generated by connecting a plurality of nodes.

As illustrated in FIG. 3, path generator 34 of arithmetic device 30 selects a few nodes from a plurality of nodes N1 to N7 set in advance, and generates path P1 for moving body 10 toward destination D1 by connecting the selected nodes.

Specifically, in storage device 32, information (map information) 42 including position information such as a travel prohibited area of moving body 10, positions of a plurality of nodes N1 to N7, and information on connection relationships between the nodes (node information) 44 is stored in advance. Path generator 34 selects a plurality of nodes N3, N4, N6, and N7 through which moving body 10 passes from the current position to destination D1 based on map information 42 and node information 44, and generates path P1 by connecting the selected nodes. At this time, path generator 34 selects the plurality of nodes such that a length and a moving time of path P1 are minimized. Destination D1 is a final destination, or a temporary relay node created by path generator 34. In addition, map information 42 and node information 44 may be acquired from the outside via communication device 20. Map information 42 may further store permanent structures such as walls W1 to W5 (that is, structures having an invariant position).

Movement controller 36 of arithmetic device 30 controls the movement of moving body 10 such that moving body 10 moves forward according to path P1 generated by path generator 34. In the present exemplary embodiment, movement controller 36 controls the movement of moving body 10 by controlling the rotation directions and rotation speeds of wheels 14L and 14R, respectively, via motor 18. In this way, moving body 10 executes moving forward, moving backward, and the direction change. In the present specification, “direction change” includes a right turn, a left turn, a U-turn, and the like, and particularly includes a pivot turn in the present exemplary embodiment.

In the present exemplary embodiment, passage determination ranges A1 to A7 are set for each of a plurality of nodes N1 to N7.

FIG. 4 illustrates an example of the passage determination range for each of a plurality of nodes.

In FIG. 4, trajectory T of reference point C of moving body 10 is illustrated. As indicated in trajectory T, moving body 10 does not pass through nodes N3, N4, N6, and N7 included in path P1, but passes through passage determination ranges A3, A4, A6, and A7 of each node. In the present exemplary embodiment, passage determination range An (n is an integer) is a circular range having a center on node Nn.

Specifically, when reference point RP of moving body 10 enters passage determination range of a certain node, it is considered that moving body 10 passes that node. Immediately, moving body 10 moves forward toward the next node. By setting such passage determination ranges, moving body 10 can move smoothly move toward the destination in a short time. On the other hand, when moving body 10 needs to pass accurately on the node, it becomes necessary to align reference point RP of moving body 10 with the node. As a result, moving body 10 repeats acceleration and deceleration, and moves with a complicated moving trajectory.

The size and shape of passage determination ranges A1 to A7 set in each of a plurality of nodes N1 to N7 may differ based on the position at which the nodes are set.

Passage determination changer 38 of arithmetic device 30 changes the size of passage determination range set in the node.

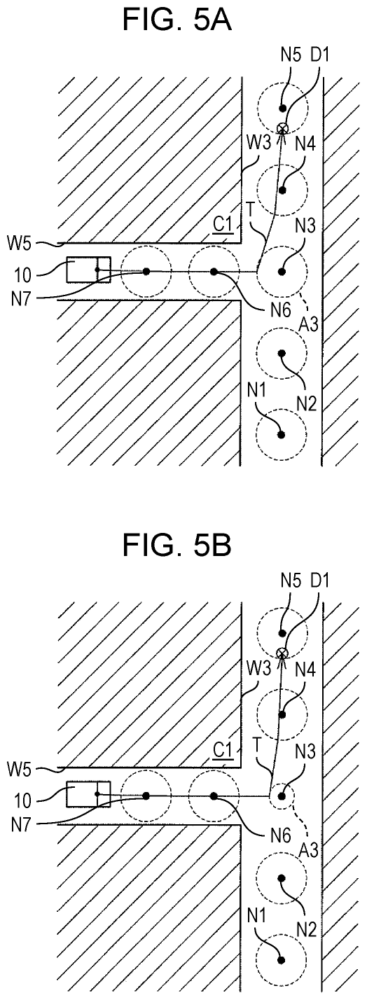

FIG. 5A illustrates a node before the passage determination range is changed. FIG. 5B illustrates the node after the passage determination range is changed.

As illustrated in FIG. 5A and FIG. 5B, passage determination changer 38 reduces the size of passage determination range A3 of node N3 on a curve (right angle curve) of path P generated by path generator 34. As a result, moving body 10 can turn left in a state of being away from corner C1 made of wall W3 and wall W5, that is, it is possible to prevent the occurrence of avoidance operation due to the interference between moving body 10 and corner C1. In addition, it is possible to further avoid a contact between moving body 10 and corner C1.

Obstacle detector 40 of arithmetic device 30 detects the obstacle around moving body 10 based on the result of measurement by range sensor 16. Obstacle detector 40 detects a permanent object such as walls W1 to W5, that is, structures included in map information 42, as obstacles of moving body 10 based on the result of measurement by range sensor 16. In addition, obstacle detector 40 detects a temporarily existing object such as a person as an obstacle of moving body 10. That is, obstacle detector 40 detects an object that can come into contact with moving body 10 as an obstacle.

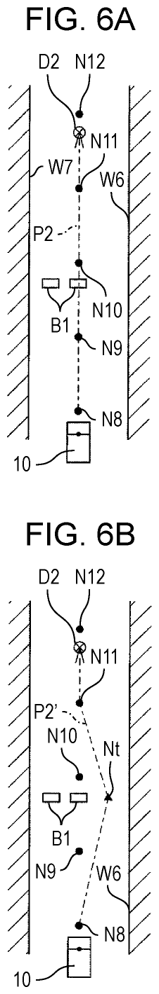

FIG. 6A illustrates an example of the obstacle existing ahead of moving body. FIG. 6B illustrates an example of a path avoiding the obstacle.

As illustrated in FIG. 6A, when moving body 10 is moving forward toward destination D2 according to path P2, obstacle detector 40 detects obstacle B1 ahead of moving body 10. When obstacle B1 is detected, path generator 34 changes path P2 such that obstacle B1 can be avoided, and generates new path P2′.

Specifically, as illustrated in FIG. 6B, first, path generator 34 temporarily generates avoidance node Nt to be passed in order to avoid obstacle B1. A space through which moving body 10 can pass is detected based on the result of measurement by range sensor 16, and then, avoidance node Nt is generated in that space. In the present exemplary embodiment, avoidance node Nt is generated in a space between obstacle B1 and wall W6. Path generator 34 generates path P2′ that passes through avoidance node Nt toward destination D2. By moving forward according to path P2′, moving body 10 can move forward, execute the direction change, avoid obstacle B1, and finally arrive at destination D2. In the present disclosure, the obstacle avoidance path is generated by temporarily generating avoidance node Nt, but the obstacle avoidance path may be generated by applying another obstacle avoidance algorithm.

Incidentally, in some cases, there may be an obstacle in the vicinity of moving body 10. That is, in some cases, there may be an obstacle that restricts the forward movement and the direction change of moving body 10. For example, a person may suddenly appear during the forward movement of moving body 10. In addition, while moving body 10 is stopped, an object such as luggage may be placed ahead of moving body 10. When there is such an obstacle, moving body 10 operates as follows.

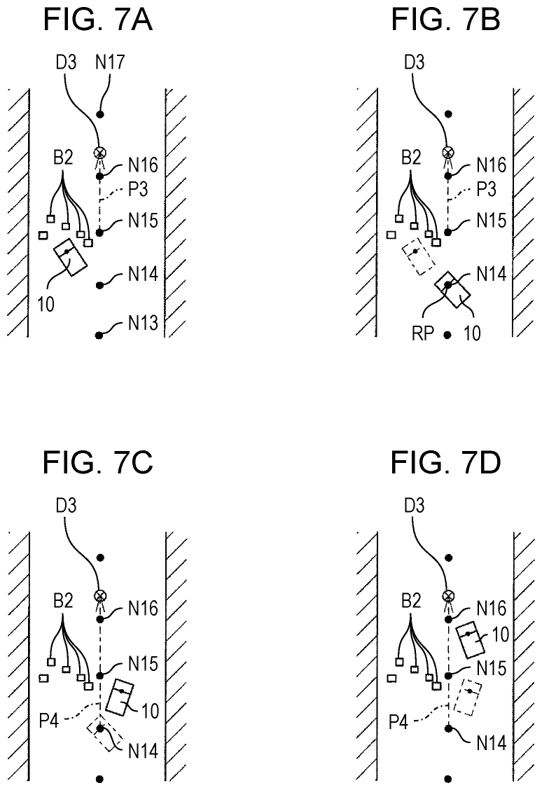

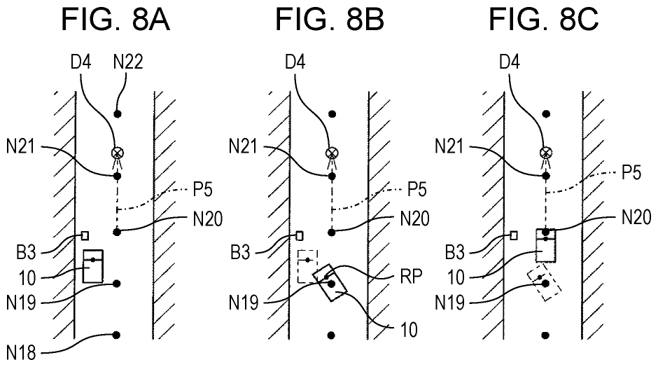

FIG. 7A to FIG. 7D illustrate an example of a moving body situation in which a destination is positioned ahead and there is an obstacle which restricts the forward movement and the direction change. FIG. 8A to FIG. 8C illustrate another example of a moving body situation in which a destination is positioned ahead and there is an obstacle which restricts the forward movement and the direction change.

As illustrated in FIG. 7A, there is obstacle B2 that restricts the forward movement and the direction change in the direction toward destination D3 ahead of moving body 10. At this time, path P3 (path including nodes N15 and N16) toward destination D3 positioned at the other side of obstacle B2 is generated. In order to move forward toward destination D3 according to path P3, moving body 10 needs to move backward for the time being and move away from obstacle B2.

In order to do that, as a backward movement destination of moving body 10, a node (retreat destination node) existing at a position behind moving body 10 where the moving body can arrive is determined. In the example illustrated in FIG. 7A, node N14 positioned behind moving body 10 is determined as the retreat destination node. The determination of the retreat destination node will be described.

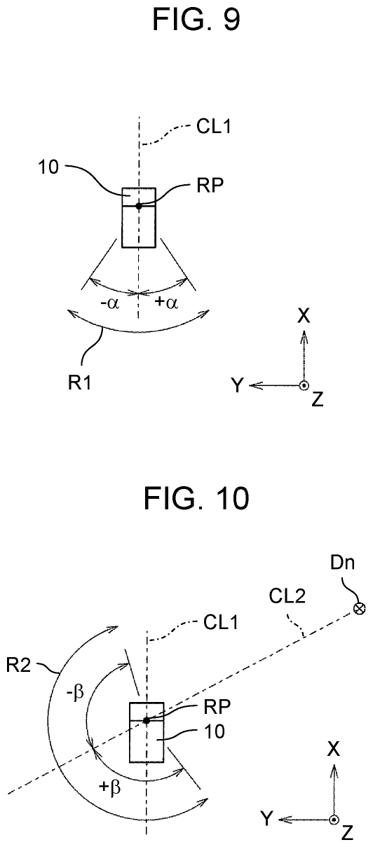

FIG. 9 and FIG. 10 are diagrams explaining methods of determining the retreat destination node.

As illustrated in FIG. 9, first, first rear range R1 for determining the retreat destination node is set for moving body 10. First rear range R1 is an angle range of a degrees to the left and right with respect to first reference line CL1 extending in the front-rear direction (X-axis direction) of moving body 10. In the present exemplary embodiment, first reference line CL1 passes through reference point RP of moving body 10 in an upward view (Z-axis direction view), and further, first rear range R1 is an angle range having reference point RP of moving body 10 as a reference. The angle α is, for example, 45 degrees or 90 degrees.

A node existing in first rear range R1 and at the closest position where moving body 10 can arrive is determined as the retreat destination node.

If there is no node which is defined to be a retreat destination node in first rear range R1, second rear range R2 illustrated in FIG. 10 is used.

As illustrated in FIG. 10, second rear range R2 is defined by a position relationship between destination Dn and reference point RP of moving body 10. First rear range R1 is a fixed range defined with respect to moving body 10, while second rear range R2 is a range that changes depending on the relative position of destination Dn to moving body 10.

Specifically, second rear range R2 is an angle range of β degrees to the left and right with respect to second reference line CL2 connecting reference point RP of moving body 10 and destination Dn. In addition, second rear range R2 is an angle range having reference point RP of moving body 10 as a reference. The angle β is, for example, 90 degrees or 135 degrees. That is, second rear range R2 is set larger than first rear range R1.

When there is no node which is defined to be a retreat destination node in first rear range R1, a node existing in second rear range R2 and at the closest position where moving body 10 can arrive is determined as the retreat destination node.

Even in a case of the node exists in first rear range R1 or second rear range R2 and at the closest position where moving body 10 can arrive, when it is not possible to execute the direction change at that node, a next closest node is determined as the retreat destination node. The determination of whether the direction change is possible or not at a node can be performed based on the result of detection of the obstacles around the node by obstacle detector 40.

In a case of the example illustrated in FIG. 7A, node N14 is determined as the retreat destination node. Movement controller 36 of arithmetic device 30 causes moving body 10 to move backward toward node N14.

As illustrated in FIG. 7B, when moving body 10 (its reference point RP) arrives at node N14 which is retreat destination node, as illustrated in FIG. 7C, path generator 34 regenerates path P4 from node N14 to destination D3.

As illustrated in FIG. 7D, movement controller 36 causes moving body 10 to move forward according to regenerated path P4. Specifically, movement controller 36 causes moving body 10 to execute the direction change to a direction in which the moving body can move forward toward destination D3. Movement controller 36 causes moving body 10 to move forward so as can avoid obstacle B2 toward destination D3.

Sometimes the direction change may be possible before moving body 10 moves backward and arrives at the retreat destination node. That is, there may be a space where the direction change can be executed. In that case, before arriving at the retreat destination node, moving body 10 may execute the direction change to a direction in which the moving body can move forward toward the destination, and may move forward toward the destination after the direction change.

For example, as illustrated in FIG. 8A and FIG. 8B, path P5 is generated, node N19 is determined as the retreat destination node, and moving body 10 moves backward toward node N19. Before moving body 10 (its reference point RP) arrives at node N19, and assuming that there is a space where the direction change can be executed, moving body 10 executes the direction change to a direction in which the moving body can move forward toward destination D4. Moving body 10 avoids obstacle B3 while moving forward toward destination D4 according to path P5. The determination of whether there is a space where the direction change can be executed or not can be executed based on the result of detection of the obstacles around moving body 10 by obstacle detector 40.

FIG. 7A to FIG. 7D and FIG. 8A to FIG. 8C illustrate the situations in which a destination is positioned ahead of moving body 10 and there is an obstacle which restricts the forward movement and the direction change of moving body 10. Next, a case where the destination is positioned behind moving body 10 will be described.

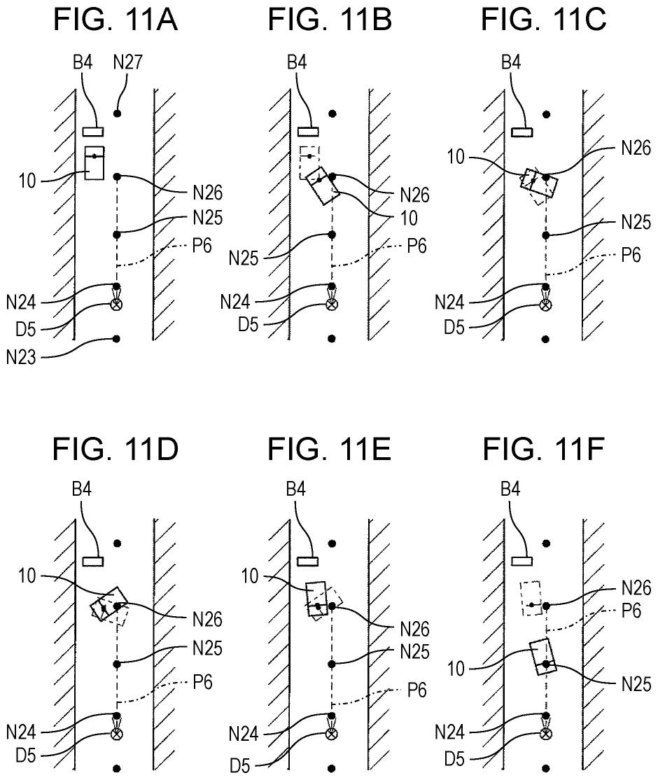

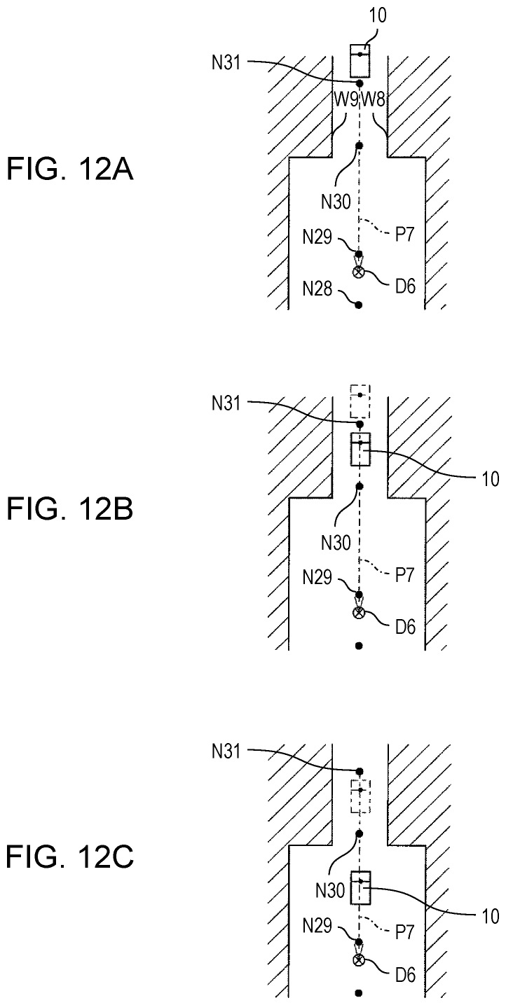

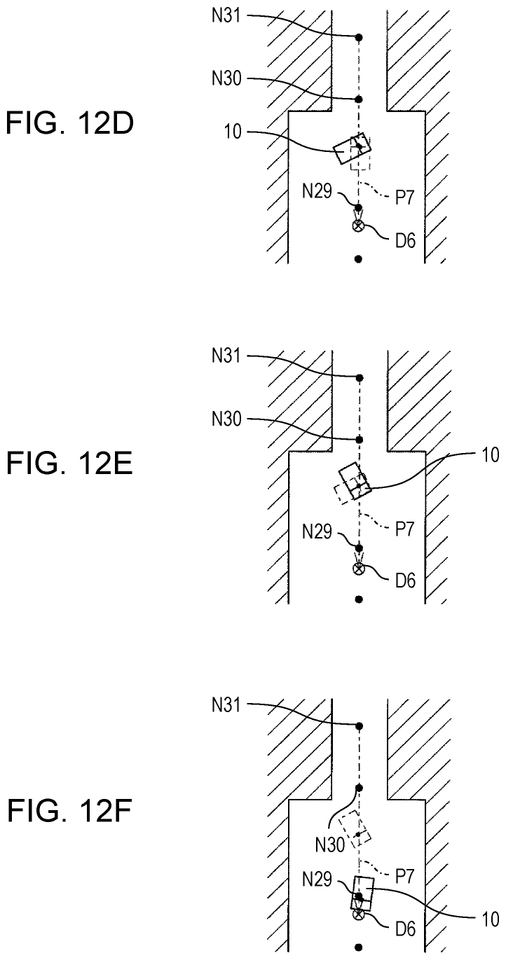

FIG. 11A to FIG. 11F illustrate the situations of a moving body in which the destination is positioned behind and there is an obstacle which restricts the forward movement and the direction change. In addition, FIG. 12A to FIG. 12F illustrate another example of the moving body situation in which the destination is positioned behind.

As illustrated in FIG. 11A, obstacle B4 that restricts the forward movement and the direction change of moving body 10 exists ahead of moving body 10. In addition, path P6 toward destination D5 positioned behind moving body 10 is generated. That is, moving body 10 is in a situation where a 180-degree direction change such as a U-turn cannot be executed. In this case, node N25 is determined as the retreat destination node. As illustrated in FIG. 11B, moving body 10 moves backward toward node N25.

Since there is a space where the direction change can be executed, during the backward movement toward node N25, moving body 10 executes the direction change to a direction in which the moving body can move forward toward destination D5, that is, executes a pivot turn of approximately 180 degrees as illustrated in FIG. 11C to FIG. 11E. After the pivot turn of approximately 180 degrees, moving body 10 moves forward toward destination D5 according to path P6, as illustrated in FIG. 11F.

As illustrated in FIG. 12A, an obstacle does not exist ahead of moving body 10. However, moving body 10 is in a situation where walls W8 and W9 become obstacles and a direction change such as a U-turn cannot be executed. In addition, path P7 toward destination D6 positioned behind moving body 10 is generated. In this case, node N29 is determined as the retreat destination node. As illustrated in FIG. 12B, moving body 10 moves backward toward node N29.

Since there is a space where the direction change can be executed, during the backward movement toward node N29, moving body 10 executes the direction change to a direction in which the moving body can move forward toward destination D6, that is, executes a pivot turn of approximately 180 degrees as illustrated in FIG. 12C to FIG. 12E. After the pivot turn of approximately 180 degrees, moving body 10 moves forward toward destination D6 according to path P7, as illustrated in FIG. 12F.

Next, a processing flow of arithmetic device 30 until the destination is determined and the moving body arrives at the destination will be described.

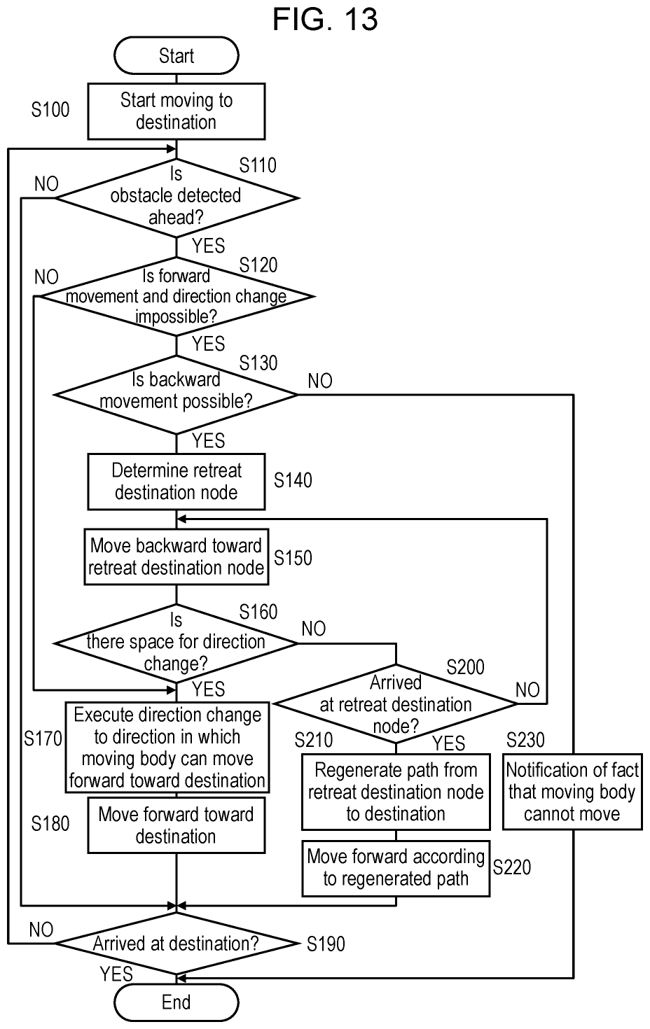

FIG. 13 is a flowchart illustrating an example of the processing flow until the moving body arrives at the destination.

As illustrated in FIG. 13, in step S100, moving body 10 starts moving to the destination.

During the forward movement of moving body 10 or before the start of the movement (before the start of the forward movement or before the start of backward movement), in step S110, determination processing for determining whether or not an obstacle is detected ahead of moving body 10 is executed by obstacle detector 40 of arithmetic device 30. If the obstacle is detected, the process proceeds to step S120. If not, the process skips to step S190.

In step S120, determination processing for determining whether or not the forward movement and the direction change of moving body 10 is not possible, that is, whether or not the obstacle detected in step S110 restricts the forward movement and direction change of moving body 10, is executed. If the forward movement and the direction change of moving body 10 are not possible, the process proceeds to step S130. If not, the process skips to step S170.

In step S130, determination processing for determining whether or not the backward movement of moving body 10 is possible is executed. If the backward movement is possible, the process proceeds to step S140. If not, that is, when moving body 10 cannot execute forward movement, the backward movement, and the direction change, the process proceeds to step S230, and arithmetic device 30 notifies of a fact that moving body 10 cannot move. For example, the notification is performed to the user of moving body 10 and persons around moving body 10. Then, the process ends. In step S130, when it is determined that moving body 10 cannot execute the forward movement, the backward movement, and the direction change, instead of immediately proceeding to step S230, waiting for a certain period of time, and after a certain period of time, steps S110 to S130 may be determined again. In this way, moving body 10 can start moving when the obstacles such as persons or the objects moving in the surroundings move away from the surroundings and the moving body becomes movable.

In step S140, the retreat destination node is determined.

In step S150, movement controller 36 of arithmetic device 30 causes moving body 10 to move backward toward the retreat destination node determined in step S140.

In step S160, during the backward movement of moving body 10, determination processing for determining whether there is a space where the direction change can be executed or not. If there is the space where the direction change can be executed, the process proceeds to step S170. If not, the process proceeds to step S200.

In step S170, movement controller 36 of arithmetic device 30 causes moving body 10 to execute the direction change in which moving body 10 can move forward toward the destination.

After the direction change of moving body 10 in step S170, in step S180, movement controller 36 of arithmetic device 30 causes moving body 10 to move forward toward the destination.

In step S190, determination processing for determining whether or not moving body 10 arrives at the destination is executed. If moving body 10 arrives at the destination, the process ends. If not, the process returns to step S110.

If it is determined in the determination processing in step S160 that there is no space where the direction change during the backward movement of moving body 10, in step S200, determination processing for determining whether moving body 10 arrived at the retreat destination node or not is executed. If moving body 10 arrives at the retreat destination node, the process proceeds to step S210. If not, the process returns to step S150.

In step S210, path generator 34 of arithmetic device 30 regenerates the path from the retreat destination node to the destination.

In step S220, movement controller 36 of arithmetic device 30 causes moving body 10 to move forward according to the path regenerated in step S200. Then, the process proceeds to step S190.

According to the present exemplary embodiment as described above, in a moving body that moves according to a path generated by connecting a plurality of nodes, even if there is an obstacle where a forward movement and a direction change are restricted, the forward movement of the moving body to a destination can be executed.

As above, the present disclosure has been described with reference to the exemplary embodiment described above, the exemplary embodiment of the present disclosure is not limited thereto.

For example, in the case of the exemplary embodiment described above, as illustrated in FIG. 1, moving body 10 can execute pivot turn with the reference point RP as a center, which is positioned at the front side with respect to the center of main body 12 in the front-rear direction (X-axis direction). However, the exemplary embodiment of the present disclosure is not limited to this. The reference point which is the turning center of the pivot turn may be positioned at the center of the moving body in the front-rear direction or on the rear side with respect to the center. In addition, the moving body may have a configuration in which pivot turn is not possible. In a broad sense, the moving body according to the present disclosure may be clearly distinguished from the front side portion and the rear side portion, and basically move toward the destination so that the front side portion precedes the rear side portion, that is, may be a moving body that moves forward.

That is, in the exemplary embodiment of the present disclosure, in a broad sense, a moving body includes a path generator that selects some nodes from a plurality of nodes set in advance and generates a path for a moving body toward a destination by connecting the selected nodes; a movement controller that controls a movement of the moving body such that the moving body moves forward according to the path; and an obstacle detector that detects an obstacle. When the obstacle detector detects an obstacle that restricts a forward movement and a direction change of the moving body, the movement controller causes the moving body to move backward toward a retreat destination node which is a node existing at a position behind the moving body where the moving body can arrive, causes the moving body to execute the direction change to a direction in which the moving body can move forward toward the destination, and causes the moving body to move forward toward the destination.

As described above, the above-described exemplary embodiment has been described as an example of the technology in the present disclosure. To that end, the accompanying drawings and detailed description are provided.

Therefore, among the configuration elements described in the accompanying drawings and the detailed description, not only the configuration elements essential for solving the problems but also the configuration elements not essential for solving the problems can also be included in order to illustrate the technology. Therefore, the fact that those non-essential configuration elements are described in the accompanying drawings or detailed description may not be immediately recognized that those non-essential configuration elements are essential.

In addition, since the exemplary embodiment described above is for exemplifying the technology in the present disclosure, various changes, replacements, additions, omissions, and the like can be made within the scope of claims or the equivalent scope thereof.

The present disclosure is applicable to a moving body that moves forward according to a path generated by connecting some nodes from a plurality of nodes set in advance.

What is claimed is:

1. A moving body comprising:
a path generator that selects nodes from a plurality of nodes set in advance and generates a path for a moving body toward a destination by connecting the selected nodes;
a movement controller that controls a movement of the moving body such that the moving body moves forward according to the path; and
an obstacle detector that detects an obstacle,
wherein, when the obstacle detector detects an obstacle that restricts a forward movement and a direction change of the moving body, the movement controller causes the moving body to move backward toward a retreat destination node which is a node existing at a position behind the moving body where the moving body can arrive, causes the moving body to execute a direction change to a direction in which the moving body can move forward toward the destination, and causes the moving body to move forward toward the destination.

2. The moving body of claim 1,
wherein, when the direction change of the moving body becomes possible during the backward movement toward the retreat destination node, the movement controller causes the moving body to execute the direction change and to move forward toward the destination before arriving at the retreat destination node.

3. The moving body of claim 1,
wherein, when the moving body arrives at the retreat destination node, the path generator regenerates a path from the retreat destination node to the destination.

4. The moving body of claim 1,
wherein a node that is in a first rear range which is 45 degrees to left and right or 90 degrees to left and right with respect to a first reference line extending in a front-rear direction of the moving body and is closest to the moving body among the plurality of nodes is defined as the retreat destination node.

5. The moving body of claim 4,
wherein, when the node which is defined as the retreat destination node does not exist in the first rear range, a node that is in a second rear range which is 90 degrees to left and right or 135 degrees to left and right with respect to a second reference line connecting a reference point of the moving body and the destination and is closest to the moving body among the plurality of nodes is the retreat destination node.

6. The moving body of claim 5,
wherein the moving body can execute a pivot turn, and
the reference point of the moving body is a turning center of the pivot turn.

7. The moving body of claim 6,
wherein the reference point of the moving body is positioned at a front side or a rear side with respect to a center the moving body in the front-rear direction.

8. The moving body of claim 1,
wherein a passage determination range is set for each of the plurality of nodes, and
the movement controller controls the movement of the moving body so as to pass through the passage determination range of each node included in the path.

9. The moving body of claim 8, further comprising:
a passage determination changer that reduces the passage determination range of the nodes on a curve when the curve is included in the path.
